(19) United States
(12) Patent Application Publication
(10) Pub. No.: US 2022/0194480 A1
(43) Pub. Date: Jun. 23, 2022

(54) MUD FLAP ASSEMBLY

(71) Applicant: B&S Horses and Trucks Customizing, Idaho Falls, ID (US)

(72) Inventors: BART STOLWORTHY, IDAHO FALLS, ID (US); STEPHANIE STOLWORTHY, IDAHO FALLS, ID (US)

(21) Appl. No.: 17/130,875

(22) Filed: Dec. 22, 2020

(51) Int. Cl. B62D 25/16; B62D 25/18

(52) U.S. Cl. CPC B62D 25/163; B60D 1/06; B62D 25/188

(57) ABSTRACT

A mud flap assembly has a bracket hanger and a mud flap. The bracket hanger has a body extending from a first end and a second end. The first end of the bracket hanger has a shape complementary to a bore of a receiver's maintube that extends along a width of the vehicle. The mud flap is connected to and extends downward from the bracket hanger. A coupler has a first end and a coupler bore opposite the first end. The first end of the coupler is complementary to an end of a maintube of a second vehicle. The coupler bore is complementary to the first end of the bracket hanger.

### BACKGROUND

### Field of the Disclosure

The embodiments described herein relate to a vehicle accessory. More particularly, the disclosure relates to systems and methods of using a mud flap with an integrated step for accessing the bed of a pickup truck.

### Description of the Related Art

Mud flaps are used to prevent debris that comes into contract with a spinning tire from being throw into a following vehicle or a trailer towed behind the primary vehicle. Mud flaps may be readily removeable but may require use of a hitch for connection to the vehicle, such as a pickup truck. When installed, known mud flaps may be mounted behind the bumper of the vehicle, which increases the overall length of the vehicle and permits debris to bound back into the bumper and tailgate. This can cause damage to the vehicle and/or dirt to be accumulated. Some vehicles may include mudguards, which are mounted within the wheel well of a vehicle in order to deflecting road debris away from the fender wells. Mudguards may not be readily removeable and provide limited protection.

FIG. 8 is an exploded view illustrating a known mud flap 20 installed upon a vehicle, such as a pickup truck 30. Mud flap 20 includes a square aperture 25 having a shape corresponding to a shank 15 of a hitch 10. The hitch 10 include a ball 11 for connecting to a trailer to be towed. The pickup truck 30 include a receiver 50 with a receiver tube 55 extending rearward from below a bumper 40 of the pickup truck 30. Bumper 40 may include a bumper step 45 positioned directly above the receiver tube 55 and extending perpendicular thereto. To install mud flap 20 upon pickup truck 30, a user inserts shank 15 of hitch 10 through square aperture 25 of mud flap 20 and into receiver tube 55. In some instances, mud flap 20 may be supported upon bumper step 45. Mud flap 20 may be, for example, clamped to shank 15 of hitch 10 to prevent movement with respect to hitch 10. When installed, mud flap 20 is positioned behind the bumper 40 of pickup truck 30 and requires hitch 10 to be mounted within receiver tube 55. To remove mud flap 20, hitch 10 must first be removed. Other disadvantages of known mud flaps and mudguards may exist.

### SUMMARY

The present disclosure is directed to methods and systems that overcome or lessen some of the problems and disadvantages discussed above. Not all embodiments provide the same advantages or the same degree of advantage.

One exemplary embodiment is a mud flap assembly having a bracket hanger and a mud flap. The mud flap assembly is compatible with a vehicle having a receiver with a maintube extending along a width of the vehicle. The bracket hanger has a body extending from a first end and a second end. The first end has a shape complementary to a bore of the maintube. The mud flap is connected to and extends downward from the bracket hanger. The mud flap is positioned closer to the second end of the bracket hanger than the first end of the bracket hanger. The first end of the bracket hanger may have a rectangular shape.

The mud flap assembly may include a coupler. The coupler may have a first end and a coupler bore opposite the first end. The first end of the coupler is complementary to an end of a maintube extending along a width of a second vehicle. The first end of the coupler has a different shape from the first end of the bracket hanger. The coupler bore is complementary to the first end of the bracket hanger. The first end of the coupler may be shaped to be received with a bore in the end of the maintube of the second vehicle. The first end of the bracket hanger may have a rectangular shape. The first end of the coupler may have a circular aperture that is complementary to the end of the maintube of the second vehicle.

The bracket hanger may be a first bracket hanger and the mud flap be a first mud flap. The maintube includes a first end and a second end. The shape of the first end of the first bracket hanger is complementary to the bore of the maintube at the first end of the maintube. The mud flap assembly may include a second bracket hanger and a second mud flap.

The second bracket hanger has a body extending from a first end and a second end. The first end of the second bracket hanger has a shape complementary to the bore of the maintube at the second end of the maintube. The second mud flap is connected to and extends downward from the second bracket hanger. The second mud flap is positioned closer to the second end of the second bracket hanger than the first end of the second bracket hanger.

One exemplary embodiment is a mud flap system having a first bracket hanger, a second bracket hanger, a first mud flap, and a second mud flap. The first bracket hanger has a first body extending between a first end and a second end. The first of the first bracket hanger is connected to a first end of a maintube of a receiver of a vehicle. The first body extends along a width of the vehicle. The first mud flap is connected to and extends downward from the first bracket hanger. The second bracket hanger has a second body extending between a first end and a second end. The first end of the second bracket hanger is connected to a second end of the maintube of the receiver of the vehicle, the second body extending along the width of the vehicle. The second mud flap is connected to and extends downward from the second bracket hanger.

The first bracket hanger may extend beyond a first side panel of the vehicle and/or the second body of the second bracket hanger may extend beyond a second side panel of the vehicle. The width of the vehicle extends between the first side panel and the second side panel.

The first end of the first bracket hanger may be complementary to a bore at the first end of the maintube and positioned within the bore at the first end of the maintube. The first end of the second bracket hanger may be complementary to a bore at the second end of the maintube and positioned within the bore at the second end of the maintube. The first end of the first bracket hanger has a rectangular shape.

The mud flap system may include a first set screw extending through a first aperture in a wall of the maintube and in contact with the first end of the first bracket hanger. The mud flap system may include a coupler having a first end and a coupler bore opposite the first end. The first end of the coupler is complementary to the first end of the maintube. The first end of the first bracket hanger is complementary to the coupler bore and positioned within the coupler bore. The first end of the coupler may be positioned within a bore at the first end of the maintube. The first end of the coupler may have a circular aperture positioned around the first end of the maintube.

One exemplary embodiment is a method of installing a mud flap. The method includes providing a mud flap assembly and connecting the mud flap assembly to a vehicle having a receiver with a maintube extending along a width of the vehicle by connecting the first end of the body of the bracket hanger to a first end of the maintube. The connection may be on the frame rails at the end of the maintube. The vehicle may include a front end, a rear end, a length extending from the front end to the rear end. The length is perpendicular to the width of the vehicle.

The first end of the maintube may include a bore. Connecting the mud flap assembly to the vehicle may include inserting the first end of the body of the bracket hanger into the bore of the maintube. The method may include sliding the first end of the bracket hanger within the bore of the maintube and securing the first end of the body of the bracket hanger within the bore of the maintube. The first end of the body of the bracket hanger may be secured to the maintube by positioning a fastener through a hole in a wall of the maintube and contacting the first end of the body of the bracket hanger. The method may include drilling the hole through the wall of the maintube. The second end of the bracket hanger may extend beyond a side panel of the vehicle when the bracket hanger is secured within the bore of the maintube.

The method may include providing a second mud flap assembly and inserting the first end of the body of the second bracket hanger into a bore of the maintube at the second end of the maintube.

The method may include providing a coupler having a first end and a coupler bore opposite the first end. The first end of the coupler is complementary to the first end of the maintube. The first end of the bracket hanger is complementary to the coupler bore. The method may include securing the first end of the coupler to the first end of the maintube and inserting the first end of the bracket hanger into the coupler bore. Securing the first end of the coupler to the first end of the maintube may include inserting the first end of the coupler into a bore of the maintube and securing the first end of the coupler within the bore of the maintube.

### BRIEF DESCRIPTION OF THE DRAWINGS

FIGS. 1 and 2 shows an embodiment of a mud flap assembly.

FIG. 3 is a detailed view of a portion of the embodiment shown in FIG. 2.

FIG. 4 is a cross-sectional view of a portion of the embodiment shown in FIG. 3.

FIG. 5 shows an embodiment of a mud flap assembly installed on a pickup truck.

FIG. 6A shows an embodiment of a mud flap assembly with a coupler.

FIG. 6B shows an embodiment of a mud flap assembly with a coupler.

FIG. 7 is a flow chart of an embodiment of a method of installing a mud flap.

FIG. 8 is an exploded view illustrating a known mud flap installed upon a vehicle.

While the disclosure is susceptible to various modifications and alternative forms, specific embodiments have been shown by way of example. The features, functions, and advantages that have been discussed can be achieved independently in various embodiments or may be combined in yet other embodiments further details of which can be seen with reference to the drawings and the following description. However, it should be understood that the disclosure is not intended to be limited to the particular forms disclosed. Rather, the intention is to cover all modifications, equivalents and alternatives falling within the scope of the disclosure as defined by the appended claims.

Furthermore, it should be understood that the figures herein are not necessary drawn to scale or uniform and certain features may be exaggerated for ease of illustration. The shapes, sizes, configurations, and/or locations of elements are shown for illustrative purposes and may be varied as would be appreciated by one of ordinary skill in the art having the benefit of this disclosure.

### DETAILED DESCRIPTION

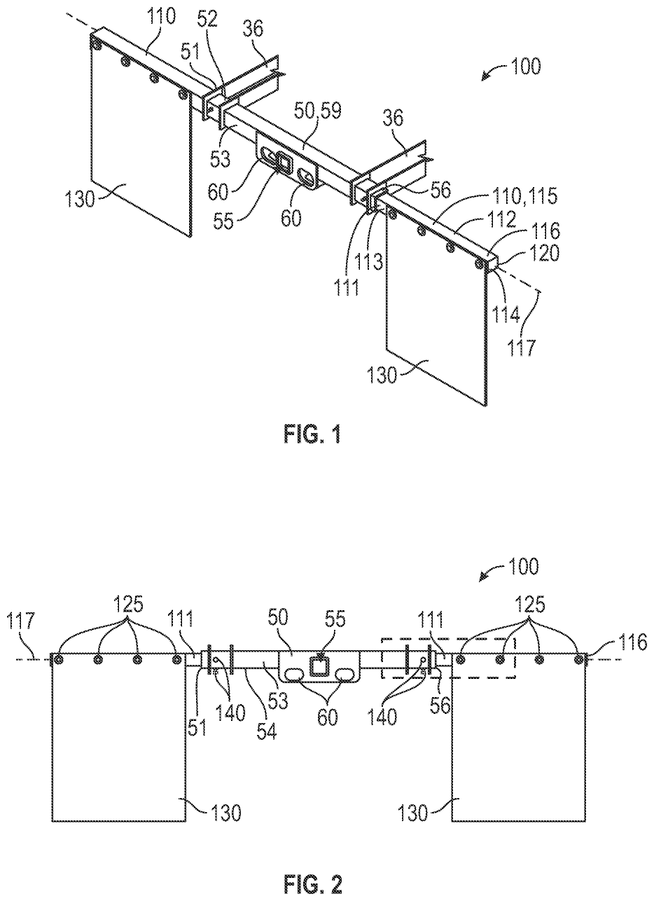

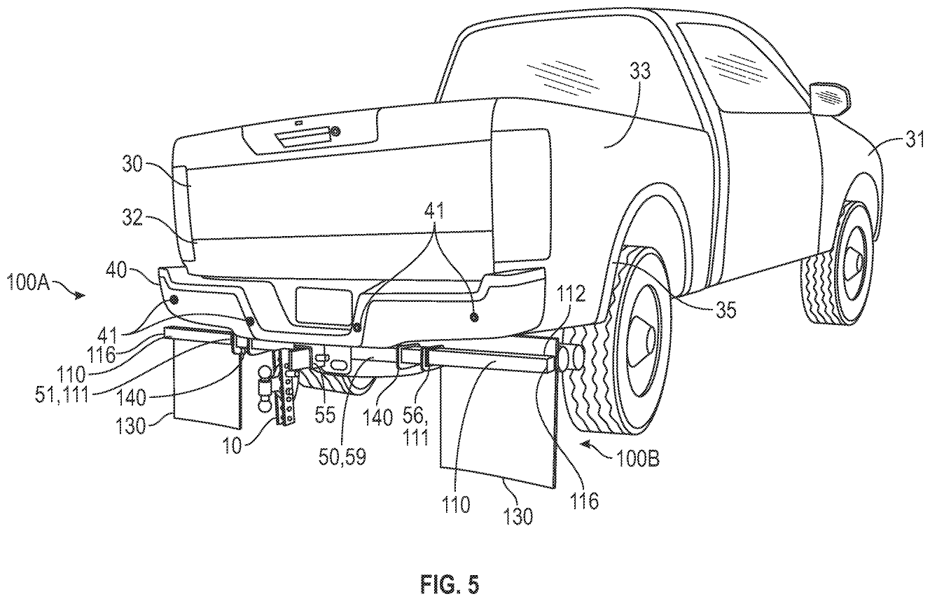

FIGS. 1 and 2 show an embodiment of a mud flap assembly 100. Mud flap assembly 100 can be used with a vehicle, such as pickup truck 30 (shown in FIG. 5) that includes a receiver 50. For purposes of illustration, only receiver 50 has been shown in FIGS. 1 and 2. Receiver 50 includes a first end 51, a second end 56, and a maintube 59 extending from first end 51 to second end 56. Located at a midpoint between first end 51 and second end 56 is a receiver tube 55 that is perpendicular to a length of maintube 59, which extends from first end 51 to second end 56. On opposing sides of receiver tube 55 are chain attachment holes 60 for connecting a safety chain of a trailer being towed (not shown). As shown in FIG. 5, maintube 59 extends along a width of pickup truck 30 and receiver tube 55 is oriented along a length of pickup truck 30. Receiver tube 55 may be a class I, class II, class II, class IV, or class V receiver, as is known the art, for receiving a hitch 10 (shown in FIG. 5). Preferably, receiver tube 55 may be a class IV or class V receiver. Maintube 59 includes a bore 58 (shown in FIG. 4) extending from first end 51 towards receiver tube 55 and extending from second end 56 towards receiver tube 55. Bore 58 may extend from first end 51 to second end 56. In some configurations, first end 51 and/or second end 56 of maintube 59 may be cut off to reveal bore 58.

Referring again to FIGS. 1 and 2, receiver 50 is supported by a plurality of frame rails 36 that extend along a length of the pickup truck 30 (shown in FIG. 5). A first frame rail 36 may be connected at first end 51 and a second frame rail 36 may be connected at second end 56, with frame rails 36 extending parallel to receiver tube 55. The first end 51 and second end 56 of maintube 59 extend to or beyond an outer side of the frame rails 36. Receiver tube 55 is located between the frame rails 36 and the mud flap assemblies 100 are positioned on the outer sides of the frame rails 36. In some configurations, maintube 59 includes a top side 52, a lateral side 53, and a bottom side 54. Maintube 59 may be a square tube with lateral side 53 perpendicular to both top side 52 and bottom side 54. Receiver tube 55 may extend beyond lateral side 53 and be perpendicular to a plane formed by lateral side 53.

Mud flap assembly 100 includes a bracket hanger 110. Bracket hanger 110 has a body 115 extending from a first end 111 to a second end 116. Body 115 may extend linearly along an axis 117 from first end 111 to second end 116. The length of body 115 may be at least 30 inches. In some embodiments, first end 111 may not be linearly aligned with second end 116 in order to provide clearance for components on an underside of pickup truck 30 (not shown in FIGS. 1 and 2). First end 111 of bracket hanger 110 is connected to first end 51 or second end 56 of maintube 59 to support mudflap assembly 100 upon the vehicle. First end 111 of bracket hanger 110 may be connected to maintube 59 by a complementary relationship or through a coupler that permits bracket hanger 110 to be secured to maintube 59 or to frame rails 36 adjacent to maintube 59.

In some embodiments, the shape of bracket hanger 110 at first end 111 is complementary to maintube 59 at first end 51 and/or second end 56 such that first end 111 of body 115 is shaped to be received within bore 58 (shown in FIG. 4) of maintube 59 and secured therein. In other embodiments, the complementary relationship may be reversed with a bore on the end of the bracket hanger and the end of the bracket hanger is received over the end of the maintube.

In some configurations, body 115 has a rectangular shape. In some embodiments, at least first end 111 has a rectangular shape. Body 115 may be formed of square tubing. Body 115 includes a top side 112. When mud flap assembly 100 is positioned on a pickup truck, top side 112 is positioned to function as a step to permit a user to access the bed of the pickup truck. Top side 112 is shaped sufficiently large to support a foot. Top side 112 may have a width of at least 2 inches (measured perpendicular to a length of body 115 that extends from first end 111 to second end 116). In some embodiments, a width of the bracket hanger 110 at the second end 116 is larger than the width of the bracket hanger 110 at the first end 111.

In some configurations, body 115 includes a top side 112, a lateral side 113, and a bottom side 114. Body 115 may be a square tube with lateral side 113 perpendicular to both top side 112 and bottom side 114. Bracket hanger 110 may include an endcap 120 positioned at second end 116. Mud flap assembly 100 includes a mud flap 130 connected to and extending downward from bracket hanger 110. Mud flaps 130 may not cover top side 112 so as to not interfere with the step function of top side 112. A plurality of flange bolts 125 may extend through mud flaps 130 and into body 115 in order to secure mud flaps 130 onto body 115. Mud flap 130 is positioned closer to second end 116 of bracket hanger 110 than first end 111 of the bracket hanger 110.

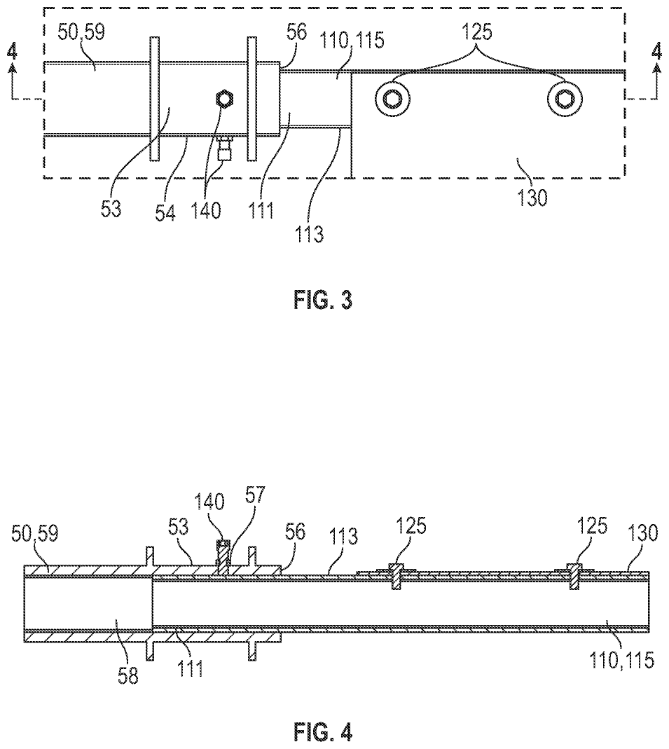

FIG. 3 is a detailed view of a portion of the embodiment shown in FIG. 2. FIG. 4 is a cross-sectional view of the portion of the embodiment shown in FIG. 3. Maintube 59 of receiver 50 is formed of walls with a bore 58 therein. Maintube 59 includes one or more apertures 57, such as a plurality of apertures 57, extending through the walls of maintube 59. Apertures 57 may be threaded. A set screw 140 may be threaded within aperture 57 and extends through the wall of maintube 59 so that set screw 140 contacts bracket hanger 110 near first end 111. As shown in FIG. 3, a set screw 140 extends through the walls formed by lateral side 53 and bottom side 54. As shown in FIG. 4, set screw 140 extending through lateral side 53 is placed into contact with lateral side 113 of body 115. Set screw 140 may be loosened so that it is no longer in contact with body 115 and bracket hanger 110 may slide within bore 58 of maintube 59 to adjust the amount of body 115 that extends beyond second end 56 of maintube 59. Mud flaps 130 are positioned against lateral side 113 of body 115 and flange bolts 125 extend through mud flaps 130, through lateral side 113, and into an interior of body 115. FIGS. 3 and 4 are illustrated with respect to second end 56 of maintube 59 but are equally applicable to another bracket hanger 110 that is received within first end 51 (shown in FIG. 1).

In another embodiment, set screw 140 may be replaced with a pin that extends through opposing walls of body 115 and through opposing walls of maintube 59. Set screws 140 may be advantageous over a pin in order to increase adjustability of bracket hanger 110.

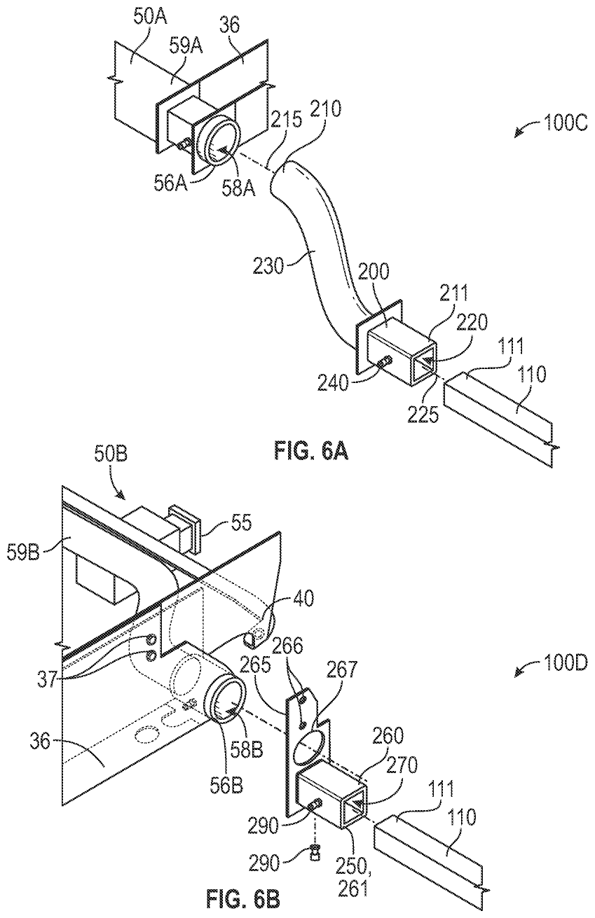

FIG. 5 shows an embodiment of a mud flap assembly 100 installed on a vehicle, such as pickup truck 30, to form a mud flap system. Pickup truck 30 includes a front end 31, a rear end 32, a length extending from front end 31 to rear end 32, and a width perpendicular to the length. The width extends between opposing side panels 33 of pickup truck 30. Pickup truck 30 includes a receiver 50 with a maintube 59 and a receiver tube 55. Maintube 59 extends along the width of pickup truck 30 and receiver tube 55 extends along the length of pickup truck 30. Receiver tube 55 is positioned between two frame rails 36 that extend along the length of pickup truck 30. First end 111 of body 115 of bracket hanger 110 is connected to bore 58 (shown in FIG. 4) of maintube 59. First end 111 may be directly connected to bore 58 by being positioned therein or may be connected indirectly through a coupler 200, 250 (shown in FIG. 6A and FIG. 6B), discussed below. As opposed to known mud flaps (such as shown in FIG. 8, which connects to the vehicle behind the bumper), mud flap assembly 100 is connected beneath bumper 40 of pickup truck 30. Mud flap assembly 100 is not positioned in the path of receiver tube 55. Notably, mud flap assembly 100 does not cover backup sensors 41 on bumper 40 of pickup truck 30.

As shown in FIG. 5, maintube 59 is located below bumper 40 of pickup truck 30 and behind (toward rear end 32) the wheel wells 35 of pickup truck 30. A first mud flap assembly 100A is connected to first end 51 of maintube 59 and a second mud flap assembly 100B is connected to second end 56 of maintube 59. First mud flap assembly 100A and second mud flap assembly 100B are collectedly and individually referred to as mud flap assembly 100. Bracket hanger 110 extends along the width of pickup truck 30 beneath bumper 40. First ends 111 of bracket hangers 110 are complementary to and inserted into first end 51 of maintube 59 and second end 56 of maintube 59, respectively. Second ends 116 of bracket hangers 110 extend beyond side panels 33 of pickup truck 30. Set screws 140 extend through maintube 59 and secure bracket hangers 110 within bore 58 (shown in FIG. 4) of maintube 59. Mud flaps 130 extend downward from bracket hangers 110 and terminate before contacting the ground. Mud flaps 130 do not interfere with top side 112 of bracket hangers 110 at second ends 116. A user may place a foot upon the top side 112 of bracket hanger 110 at second end 116 in order to hoist themselves upward to access the bed of pickup truck 30. Receiver tube 55 is unaffected by mud flap assembly 100 and a hitch 10 may be installed and removed without manipulation of mud flap assembly 100. Mud flap assembly 100 may be installed onto maintube 59 with hitch 10 already installed into receiver tube 55.

FIG. 6A shows an embodiment of a mud flap assembly 100C with a coupler 200. Mud flap assembly 100C is similar to mud flap assembly 100 but includes a coupler 200 that permits bracket hangers 110 of mud flap assembly 100 to be used with different vehicles. Another vehicle includes a receiver 50A with a maintube 59A that extends along a width of the vehicle. Maintube 59A includes a bore 58A at its end 56A that has a different shape from bore 58 of maintube 59 (shown in FIG. 4).

Coupler 200 includes a first end 210 and a coupler bore 220 at a second end 211. First end 210 of coupler 200 is complementary to bore 58A of maintube 59A. First end 111 of bracket hanger 110 is complementary to coupler bore 220 of coupler 200. First end 210 of coupler 200 has a different shape from first end 111 of bracket hanger 110. First end 210 of coupler 200 is received within bore 58A of maintube 59A and first end 111 of bracket hanger 110 is received within coupler bore 220 of coupler 200. First end 111 of bracket hanger 110 may have a rectangular shape, such as a square shape, and first end 210 of coupler 200 may have a circular shape.

First end 210 is aligned along a first axis 215 and second end 211 is aligned along a second axis 225. In some embodiments, first axis 215 is co-axial with second axis 225. Coupler 200 may include a transition section 230 between first end 210 and second end 211. Transition section 230 causes first axis 215 and second axis 225 to not be co-axial. First axis 215 and second axis 225 may be parallel. In some embodiments, a transition section may be incorporated directly into bracket hanger 110. A coupler 200 with transition section 230 may be advantageous to permit use of bracket hanger 110 with a vehicle where its corresponding maintube is not positioned entirely below the bumper of the vehicle, such as where the side panels or bumper of the vehicle extend below the ends of the maintube. A set screw 240 may extend through the wall of maintube 59A so that set screw 240 contacts bracket hanger 110 near first end 111.

By way of example, the maintube of a 2019 Ford F-350 may have a square cross-section and be located entirely below the bumper. Accordingly, a bracket hanger having a first end with a square shape may be received within the maintube. Also, by way of example, the maintube of a 2019 Chevrolet Silverado 3500 may have a circular cross-section and a portion of the bumper may extend below the ends of the maintube. Accordingly, a second bracket hanger having a first end with a circular shape may be received within this maintube. A coupler 200 with transition section 230 may be advantageous to permit, for example, use of a bracket hanger designed for use with a 2019 Ford F-350 to be used on a 2019 Chevrolet Silverado 3500 if the user were to change vehicles.

FIG. 6B shows an embodiment of a mud flap assembly 100D with a coupler 250. Mud flap assembly 100D is similar to mud flap assembly 100 but includes a coupler 250 that permits bracket hangers 110 of mud flap assembly 100 to be used with different vehicles. Another vehicle includes a receiver 50B with a maintube 59B that extends along a width of the vehicle. For purposes of illustration, side panels of the vehicle have been omitted and a portion of frame rail 36 has been shown as transparent. Maintube 59B sweeps backward from receiver tube 55 and extends through frame rail 36 such that its end 56B is on an outer side of frame rail 36. Unlike receivers 50 and 50A, discussed above, in some embodiments, maintube 59B may not include a bore 58B. By way of example, the maintube of a 2019 Ram 2500 may not have a bore.

Coupler 250 includes a first end 260 and a coupler bore 270 at a second end 261. First end 111 of bracket hanger 110 is complementary to coupler bore 270 of coupler 250. First end 111 of bracket hanger 110 is received within coupler bore 270 of coupler 250. First end 260 of coupler 250 includes a plate 265 configured to attach to the maintube 59B or frame rails 36 of a vehicle. Plate 265 may extend perpendicular to a length of coupler 250 extending between first end 260 and second end 261. Plate 265 may include bolt apertures 266 arranged in a pattern to be aligned with factory bolts 37 on the receiver 50B or frame rails 36 of the vehicle.

In some embodiments, plate 265 may include a second aperture 267 that is larger than bolt apertures 266. Second aperture 267 is complementary to end 56B of maintube 59B such that it is shaped to receive end 56B of maintube 59B. Second aperture 267 is positioned around end 56B of maintube 59B and bolt apertures 266 are aligned with factory bolts 37. Second aperture 267 may be a circular aperture. A set screw 290 may extend through the wall of maintube 59B so that set screw 290 contacts bracket hanger 110 near first end 111.

A coupler 250 may be advantageous to permit, for example, use of a bracket hanger designed for use with a 2019 Ford F-350 to be used on a 2019 Chevrolet Silverado 3500 if the user were to change vehicles.

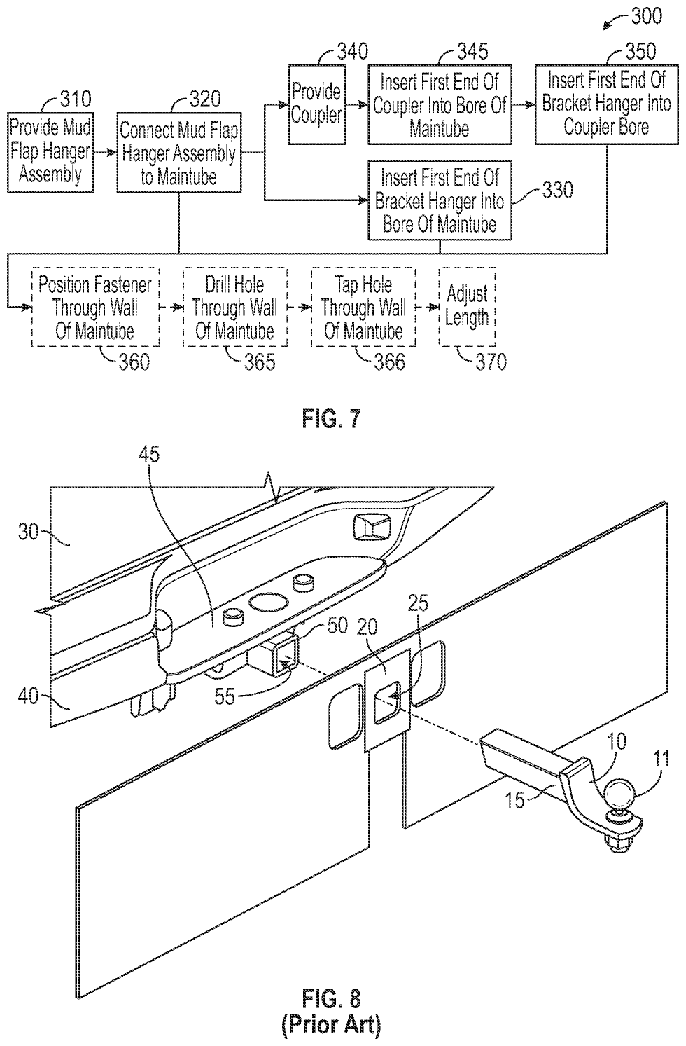

FIG. 7 is a flow chart of an embodiment of a method 300 of installing a mud flap on a vehicle. Method 300 may be repeated for installing mud flaps on both sides of a vehicle. Method 300 includes Action 310 of providing a mud flap assembly. The mud flap assembly has a bracket hanger with a body extending from a first end and a second end and mud flap connected to and extending downward from the bracket hanger. Method 300 includes Action 320 of connecting the mud flap assembly to a vehicle having a receiver with a maintube extending along a width of the vehicle. The first end of the body of the bracket hanger may be connected to the vehicle through a bore of the maintube. Method 300 may include Action 330 or Action 340, 345, 350.

Action 330 includes inserting the first end of the body of the bracket hanger into the bore of the maintube. The mud flap assembly is then secured to the maintube. Method 300 may include Actions 360, 365, and/or 370. In Action 360, the first end of the body of the bracket hanger is secured to the maintube by positioning a fastener, such as a set screw or pin, through a wall of the maintube. If a set screw is used, the set screw may contact the first end of the body of the bracket hanger. Action 365 includes drilling a hole through a wall of the maintube. The drilled hole may then be tapped in Action 366. The length of the mud flap assembly may be adjusted in Action 370. For example, the set screw may be loosened and the bracket hanger may slide within the bore of the maintube to adjust the amount of the bracket hanger that extends beyond the end of the maintube.

Action 340 includes providing a coupler. The coupler has a first end and a coupler bore. The first end of the coupler is complementary to the bore of the maintube. The first end of the bracket hanger is complementary to the coupler bore. The bore of the maintube has a different shape from the coupler bore. In Action 345, the first end of the coupler is inserted into the bore of the maintube. In Action 350, the first end of the bracket hanger is inserted into the coupler bore. The mud flap assembly is then secured to the maintube through the coupler. Actions 360, 365, 366 may be used to secure the coupler to the maintube with a fastener and/or repeated to secure the bracket hanger of the mud flap assembly to the coupler with a fastener.

Although this disclosure has been described in terms of certain preferred embodiments, other embodiments that are apparent to those of ordinary skill in the art, including embodiments that do not provide all of the features and advantages set forth herein, are also within the scope of this disclosure. Accordingly, the scope of the present disclosure is defined only by reference to the appended claims and equivalents thereof.

What is claimed is:

1. A mud flap assembly for a vehicle having a receiver with a maintube extending along a width of the vehicle, the mud flap assembly comprising:
a bracket hanger having a body extending from a first end and a second end, the first end having a shape complementary to a bore of the maintube; and
a mud flap connected to and extending downward from the bracket hanger, the mud flap positioned closer to the second end of the bracket hanger than the first end of the bracket hanger.

2. The mud flap assembly of claim 1, wherein the first end of the bracket hanger has a rectangular shape.

3. The mud flap assembly of claim 1, further comprising a coupler having a first end and a coupler bore opposite the first end, the first end of the coupler being complementary to an end of a maintube extending along a width of a second vehicle, the first end of the coupler having a different shape from the first end of the bracket hanger, and the coupler bore being complementary to the first end of the bracket hanger.

4. The mud flap assembly of claim 3, wherein the first end of the coupler is shaped to be received with a bore in the end of the maintube of the second vehicle.

5. The mud flap assembly of claim 3, wherein the first end of the coupler has a circular aperture complementary to the end of the maintube of the second vehicle.

6. The mud flap assembly of claim 1, wherein the bracket hanger is a first bracket hanger, the mud flap is a first mud flap, the maintube includes a first end and a second end, the shape of the first end of the first bracket hanger is complementary to the bore of the maintube at the first end of the maintube, and further comprising:
a second bracket hanger having a body extending from a first end and a second end, the first end of the second bracket hanger having a shape complementary to the bore of the maintube at the second end of the maintube; and
a second mud flap connected to and extending downward from the second bracket hanger, the second mud flap positioned closer to the second end of the second bracket hanger than the first end of the second bracket hanger.

7. A mud flap system comprising:
a first bracket hanger with a first body extending between a first end and a second end, the first end of the first bracket hanger being connected to a first end of a maintube of a receiver of a vehicle, the first body extending along a width of the vehicle;
a first mud flap connected to and extending downward from the first bracket hanger;
a second bracket hanger with a second body extending between a first end and a second end, the first end of the second bracket hanger being connected to a second end of the maintube of the receiver of the vehicle, the second body extending along the width of the vehicle; and
a second mud flap connected to and extending downward from the second bracket hanger.

8. The mud flap system of claim 7, wherein the first body of the first bracket hanger extends beyond a first side panel of the vehicle and the second body of the second bracket hanger extends beyond a second side panel of the vehicle, the width of the vehicle extending between the first side panel and the second side panel.

9. The mud flap system of claim 7, wherein the first end of the first bracket hanger is complementary to a bore at the first end of the maintube and positioned within the bore at the first end of the maintube, and the first end of the second bracket hanger is complementary to a bore at the second end of the maintube and positioned within the bore at the second end of the maintube.

10. The mud flap system of claim 9, further comprising a first set screw extending through a first aperture in a wall of the maintube and in contact with the first end of the first bracket hanger.

11. The mud flap system of claim 7, further comprising a coupler having a first end and a coupler bore opposite the first end, the first end of the coupler is complementary to the first end of the maintube, the first end of the first bracket hanger is complementary to the coupler bore and positioned within the coupler bore.

12. The mud flap system of claim 11, wherein the first end of the coupler is complementary to and positioned within a bore at the first end of the maintube.

13. The mud flap system of claim 11, wherein the first end of the coupler has a circular aperture positioned around the first end of the maintube.

14. A method of installing a mud flap, the method comprising:
providing a mud flap assembly having:
a bracket hanger with a body extending between a first end and a second end; and
a mud flap connected to and extending downward from the bracket hanger; and
connecting the mud flap assembly to a vehicle having a receiver with a maintube extending along a width of the vehicle by connecting the first end of the body of the bracket hanger to a first end of the maintube.

15. The method of claim 14, wherein the first end of the maintube includes a bore, and connecting the mud flap assembly to the vehicle comprises inserting the first end of the body of the bracket hanger into the bore of the maintube.

16. The method of claim 15, further comprising:
sliding the first end of the bracket hanger within the bore of the maintube; and
securing the first end of the body of the bracket hanger within the bore of the maintube.

17. The method of claim 16, wherein the second end of the bracket hanger extends beyond a side panel of the vehicle when the bracket hanger is secured within the bore of the maintube.

18. The method of claim 16, further comprising:
providing a second mud flap assembly having:
a second bracket hanger with a body extending from a first end and a second end; and
a second mud flap connected to and extending downward from the second bracket hanger; and
inserting the first end of the body of the second bracket hanger into a bore of the maintube at the second end of the maintube.

19. The method of claim 16, further comprising securing the first end of the body of the bracket hanger to the maintube by positioning a fastener through a hole in a wall of the maintube and contacting the first end of the body of the bracket hanger.

20. The method of claim 19, further comprising drilling the hole through the wall of the maintube.

21. The method of claim 14, further comprising:
providing a coupler having a first end and a coupler bore opposite the first end, the first end of the coupler is complementary to the first end of the maintube, and the first end of the bracket hanger is complementary to the coupler bore;
securing the first end of the coupler to the first end of the maintube; and
inserting the first end of the bracket hanger into the coupler bore.

22. The method of claim 21, wherein securing the first end of the coupler to the first end of the maintube comprises:
inserting the first end of the coupler into a bore of the maintube; and
securing the first end of the coupler within the bore of the maintube.
